(19) United States
(12) Patent Application Publication
(10) Pub. No.: US 2024/0384180 A1
(43) Pub. Date: Nov. 21, 2024

(54) HOT RECYCLED CONTENT PYROLYSIS VAPOR DIRECTLY TO CROSS-OVER SECTION OF CRACKER FURNACE

(71) Applicant: Eastman Chemical Company, Kingsport, TN (US)

(72) Inventors: Michael Gary Polasek, Longview, TX (US); Avery L. Anderson, Longview, TX (US); Daryl Bitting, Longview, TX (US); David Eugene Slivensky, Tatum, TX (US); Xianchun Wu, Longview, TX (US)

(73) Assignee: Eastman Chemical Company, Kingsport, TN (US)

(21) Appl. No.: 18/692,899

(22) PCT Filed: Sep. 16, 2022
(86) PCT No.: PCT/US2022/043748

§ 371 Date: Mar. 18, 2024

Related U.S. Application Data
(60) Provisional application No. 63/261,420, filed on Sep. 21, 2021.

(51) Int. Cl. C10G 9/14; C10B 53/07; C10B 57/14

(52) U.S. Cl. CPC C10G 9/14; C10B 53/07; C10B 57/14; C10G 2300/1003; C10G 2300/4081

(57) ABSTRACT

Processes and facilities for providing recycled content hydrocarbon products (r-products) from the pyrolysis of waste plastic are provided. Processing schemes are described herein that increase energy efficiency and help reduce overall environmental impact while producing valuable final products from chemically recycled waste plastic.

### BACKGROUND

Waste plastic pyrolysis plays a part in a variety of chemical recycling technologies. Typically, waste plastic pyrolysis facilities produce recycled content pyrolysis oil (r-pyoil) and recycled content pyrolysis gas (r-pygas) that can be further processed to provide a variety of recycled content chemical products and intermediates, such as recycled content ethylene (r-ethylene), recycled content ethane (r-ethane), recycled content propylene (r-propylene), recycled content propane (r-propane) and others. Unfortunately, under conventional operation, interconnected pyrolysis and product separation facilities can lack energy efficiency, which can be costly from both a financial and environmental standpoint.

### SUMMARY

In one aspect, the present technology concerns a process for making a recycled content hydrocarbon product (r-product), the process comprising: (a) pyrolyzing waste plastic in a pyrolysis facility to thereby produce a recycled content pyrolysis vapor (r-pyrolysis vapor); (b) withdrawing at least a portion of the r-pyrolysis vapor from a first location within the pyrolysis facility, wherein the r-pyrolysis vapor has a temperature at the first location, T1; (c) combining the r-pyrolysis vapor with a cracker stream to form a combined cracker stream a second location within a cracker furnace of a co-located cracking facility, wherein the r-pyrolysis vapor has a temperature at the second location, T2; and (d) cracking the combined cracker stream in the cracker furnace to form a recycled content olefin-containing effluent (r-olefin effluent), wherein the absolute value of the difference between T2 and T1 is not more than 250° C.

In one aspect, the present technology concerns a process for making a recycled content hydrocarbon product (r-product), the process comprising: (a) pyrolyzing waste plastic in a pyrolysis facility to thereby produce a recycled content pyrolysis vapor (r-pyrolysis vapor); and (b) introducing at least a portion of the r-pyrolysis vapor into a cross-over pipe of a cracker furnace in a cracking facility, wherein at least 50 weight percent of the r-pyrolysis vapor introduced into the cross-over pipe in step (b) has not been condensed.

In one aspect, the present technology concerns a process for making a recycled content hydrocarbon product (r-product), the process comprising: (a) pyrolyzing waste plastic in a pyrolysis facility to thereby produce a recycled content pyrolysis vapor (r-pyrolysis vapor); (b) cracking a hydrocarbon-containing cracker feed in a cracking furnace in a cracker facility to provide a cracked effluent, wherein the cracker furnace comprises a convection section, a radiant section, and a cross-over pipe therebetween, wherein none of the r-pyrolysis vapor is introduced into the cross-over pipe of the cracker furnace; (c) subsequent to step (b), reducing the flow rate of cracker feed to the convection section; (d) subsequent to step (c), initiating the introduction of at least a portion of the r-pyrolysis vapor into the cross-over pipe of the cracker furnace; and (e) modifying the convection section of the cracker furnace or its operation to maintain a furnace heat balance despite the reduction in cracker feed to the convection section.

### BRIEF DESCRIPTION OF THE DRAWINGS

FIG. 1 is a block flow diagram illustrating the main steps of a process and facility for pyrolyzing waste plastic and introducing at least a portion of the r-pyrolysis vapor into a cracker furnace.

FIG. 2 is a block flow diagram illustrating embodiments where the r-pyrolysis vapor is introduced between the convection and radiant sections of the cracker furnace;

FIG. 3 is a schematic diagram illustrating the main components of a cracker furnace;

FIG. 4a is a schematic diagram illustrating the main steps of a process and system for the formation of r-pyrolysis vapor in a pyrolysis facility and its introduction into a cracker furnace, particularly illustrating certain temperature locations; and

FIG. 4b is a schematic diagram illustrating the main steps of a process and system for the formation of r-pyrolysis vapor in a pyrolysis facility and its introduction into a cracker furnace, particularly illustrating exemplary modifications made to the cracker furnace in order to maintain the furnace heat balance.

### DETAILED DESCRIPTION

We have discovered a method of heat integrating pyrolysis and cracking facilities in order to enhance energy efficiency. By eliminating cooling steps for streams passed from a pyrolysis facility to a co-located cracker facility, more efficient energy usage can be realized, which also helps minimize global warming potential (GWP) of the entire process, while also providing valuable recycled content chemicals and intermediates.

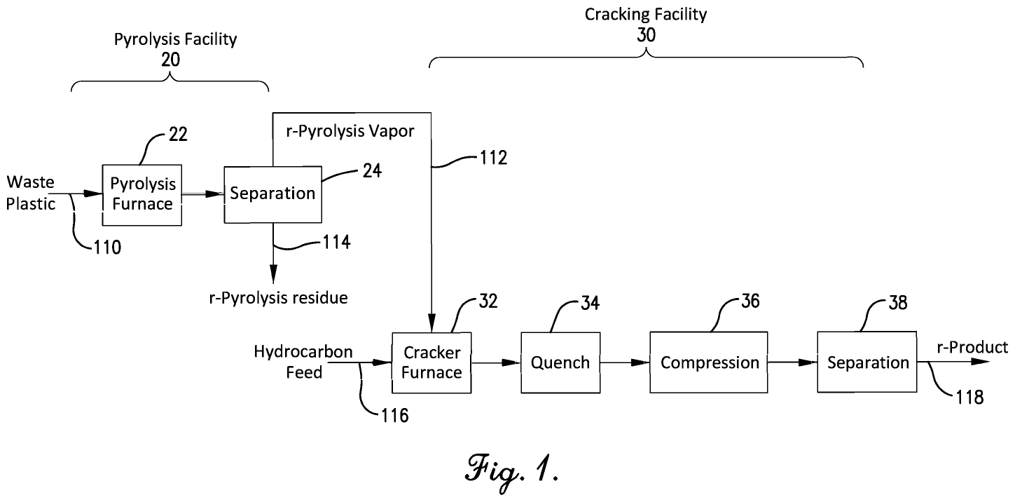

Turning first to FIG. 1, a process and system for use in chemical recycling of waste plastic is provided. The process shown in FIG. 1 includes a pyrolysis facility 20 and a cracking facility 30. The pyrolysis facility 20 and cracking facility 30 may be co-located. As used herein, the term “co-located” refers to the characteristic of at least two objects being situated on a common physical site, and/or within 1, within 0.75, within 0.5, or within 0.25 miles of each other, measured as a straight-line distance between two designated points.

When two or more facilities are co-located, the facilities may be integrated in one or more ways. Examples of integration include, but are not limited to, heat integration, utility integration, waste-water integration, mass flow integration via conduits, office space, cafeterias, integration of plant management, IT department, maintenance department, and sharing of common equipment and parts, such as seals, gaskets, and the like.

In some embodiments, the pyrolysis facility/process 20 is a commercial scale facility/process receiving the waste plastic feedstock 110 at an average annual feed rate of at least 100, or at least 500, or at least 1,000, at least 2,000, at least 5,000, at least 10,000, at least 50,000, or at least 100,000 pounds per hour, averaged over one year. Further, the pyrolysis facility 20 can produce the one or more recycled content product streams at an average annual rate of at least 100, or at least 1,000, or at least 5,000, at least 10,000, at least 50,000, or at least 75,000 pounds per hour, averaged over one year. When more than one r-product stream is produced, these rates can apply to the combined rate of all r-products.

Similarly, the cracking facility/process 30 can be a commercial scale facility/process receiving hydrocarbon feed 116 at an average annual feed rate of at least at least 100, or at least 500, or at least 1,000, at least 2,000, at least 5,000, at least 10,000, at least 50,000, or at least 75,000 pounds per hour, averaged over one year. Further, the cracking facility 30 can produce at least one recycled content product stream (r-product) at an average annual rate of at least 100, or at least 1,000, or at least 5,000, at least 10,000, at least 50,000, or at least 75,000 pounds per hour, averaged over one year. When more than one r-product stream is produced, these rates can apply to the combined rate of all r-products.

As shown in FIG. 1, the process starts with a pyrolysis step where waste plastic 110 is pyrolyzed in a pyrolysis reactor, or furnace, 22. The pyrolysis reaction involves chemical and thermal decomposition of sorted waste plastic introduced into the reactor. Although all pyrolysis processes may be generally characterized by a reaction environment that is substantially free of oxygen, pyrolysis processes may be further defined by other parameters such as the pyrolysis reaction temperature within the reactor, the residence time in the pyrolysis reactor, the reactor type, the pressure within the pyrolysis reactor, and the presence or absence of pyrolysis catalysts.

The pyrolysis reactor 22 depicted in FIG. 1 can be a film reactor, a screw extruder, a tubular reactor, a tank, a stirred tank reactor, a riser reactor, a fixed bed reactor, a fluidized bed reactor, a rotary kiln, a vacuum reactor, a microwave reactor, or an autoclave.

The pyrolysis reaction can involve heating and converting the waste plastic feedstock in an atmosphere that is substantially free of oxygen or in an atmosphere that contains less oxygen relative to ambient air. For example, the atmosphere within the pyrolysis reactor 22 may comprise not more than 5, not more than 4, not more than 3, not more than 2, not more than 1, or not more than 0.5 weight percent of oxygen.

The temperature in the pyrolysis reactor 22 can be adjusted to facilitate the production of certain end products. In some embodiments, the peak pyrolysis temperature in the pyrolysis reactor can be at least 325° C., or at least 350° C., or at least 375° C., or at least 400° C. Additionally or alternatively, the peak pyrolysis temperature in the pyrolysis reactor can be not more than 800° C., not more than 700° C., or not more than 650° C., or not more than 600° C., or not more than 550° C., or not more than 525° C., or not more than 500° C., or not more than 475° C., or not more than 450° C., or not more than 425° C., or not more than 400° C. More particularly, the peak pyrolysis temperature in the pyrolysis reactor can range from 325 to 800° C., or 350 to 600° C., or 375 to 500° C., or 390 to 450° C., or 400 to 500° C.

The residence time of the feedstock within the pyrolysis reactor 22 can be at least 1, or at least 5, or at least 10, or at least 20, or at least 30, or at least 60, or at least 180 seconds. Additionally, or alternatively, the residence time of the feedstock within the pyrolysis reactor 22 can be less than 2, or less than 1, or less than 0.5, or less than 0.25, or less than 0.1 hours. More particularly, the residence time of the feedstock within the pyrolysis reactor 22 can range from 1 second to 1 hour, or 10 seconds to 30 minutes, or 30 seconds to 10 minutes.

The pyrolysis reactor 22 can be maintained at a pressure of at least 0.1, or at least 0.2, or at least 0.3 barg and/or not more than 60, or not more than 50, or not more than 40, or not more than 30, or not more than 20, or not more than 10, or not more than 8, or not more than 5, or not more than 2, or not more than 1.5, or not more than 1.1 barg. The pressure within the pyrolysis reactor 22 can be maintained at atmospheric pressure or within the range of 0.1 to 60, or 0.2 to 10, or 0.3 to 1.5 barg.

The pyrolysis reaction in the reactor can be thermal pyrolysis, which is carried out in the absence of a catalyst, or catalytic pyrolysis, which is carried out in the presence of a catalyst. When a catalyst is used, the catalyst can be homogenous or heterogeneous and may include, for example, certain types of zeolites and other mesostructured catalysts.

As shown in FIG. 1, a pyrolysis effluent stream removed from the pyrolysis furnace 22 can be separated in a separator 24 to produce a recycled content pyrolysis vapor (r-pyrolysis vapor) 112 and a recycled content pyrolysis residue (r-pyrolysis residue) 114. As used herein, the term “r-pyrolysis effluent” refers to the outlet stream withdrawn from the pyrolysis reactor 22, and the term “r-pyrolysis vapor” refers to the overhead or vapor-phase stream withdrawn from the separator 24 used to remove r-pyrolysis residue from the r-pyrolysis effluent. As used herein, the term “r-pyrolysis residue” refers to a composition obtained from waste plastic pyrolysis that comprises predominantly pyrolysis char and pyrolysis heavy waxes. As used herein, the term “pyrolysis char” refers to a carbon-containing composition obtained from pyrolysis that is solid at 200° C. and 1 atm. As used herein, the term “pyrolysis heavy waxes” refers to C20+ hydrocarbons obtained from pyrolysis that are not pyrolysis char, pyrolysis gas, or pyrolysis oil.

As used herein, the term “pyrolysis vapor” refers to the overhead or vapor-phase stream removed from the separator used to remove pyrolysis residue from the pyrolysis reactor effluent such as, for example, separator 24 shown in FIG. 1. The r-pyrolysis vapor can include a range of hydrocarbon materials and may comprise both recycled content pyrolysis gas (r-pygas) and recycled content pyrolysis oil (r-pyoil). As used herein, the term “r-pygas” refers to a composition obtained from waste plastic pyrolysis that is gaseous at 25° C. at 1 atm. As used herein, the terms “r-pyoil” refers to a composition obtained from waste plastic pyrolysis that is liquid at 25° C. and 1 atm. In some embodiments, the pyrolysis facility 20 may include an additional separator (not shown) to separate the r-pyoil and r-pygas into separate streams, while in other embodiments (such as shown in FIG. 1), the entire stream of r-pyrolysis vapor 112 may be removed from the pyrolysis facility 20.

When removed as single stream as shown in FIG. 1, the r-pyrolysis vapor 112 can include at least 5, at least 10, at least 15, at least 20, at least 25, at least 30, at least 35, at least 50, at least 75 or at least 90 weight percent of r-pyoil and/or not more than 99, not more than 90, not more than 75, not more than 65, not more than 60, not more than 55, not more than 50, not more than 45, or not more than 40 weight percent of r-pyoil, and at least 5, at least 10, at least 20, at least 25, at least 30, at least 35, or at least 40 weight percent r-pygas and/or not more than 75, not more than 70, not more than 65, not more than 60, not more than 55, not more than 50, not more than 40, not more than 25, or not more than 10 weight percent r-pygas. The r-pyrolysis vapor 112 includes little or no r-pyrolysis residue (e.g., pyrolysis heavy waxes or char) and can, for example, include not more than 10, not more than 5, not more than 2, not more than 1, not more than 0.5, or not more than 0.1 weight percent of r-pyrolysis residue including, for example, r-heavy waxes.

In some embodiments, the r-pyrolysis vapor 112 can include C1 to C30 hydrocarbon components in an amount of at least 75, at least 90, at least 95, or at least 99 weight percent. The r-pyrolysis vapor 112 can include at least 30, at least 35, at least 40, at least 45, at least 50, at least 55, at least 60, at least 65, at least 70, at least 75, at least 80, or at least 85 weight percent of C5 and heavier components, or of C6 and heavier components, or of C8 and heavier components, or of C10 and heavier components. As used herein, the terms “Cx” or “Cx hydrocarbon” or “Cx component” refers to a hydrocarbon compound including “x” total carbons per molecule, and encompasses all olefins, paraffins, aromatics, heterocyclic, and isomers having that number of carbon atoms. For example, each of normal, iso, and tert-butane and butene and butadiene molecules would fall under the general description “C4” or “C4 components.” As used herein, the term “heavier” means having a higher boiling point and “lighter” means having a lower boiling point.

In some embodiments, at least a portion or all of the r-pyrolysis vapor 112 from pyrolysis facility 20 may be introduced directly into a cracker furnace 32 of the cracker facility 30. That is, at least 50, at least 75, at least 90, or at least 95 weight percent of the r-pyrolysis vapor 112 withdrawn from the pyrolysis facility 20 can be introduced into the cracker furnace 32 without any cooling and little, if any, condensation. For example, the r-pyrolysis vapor 112 after being withdrawn from the pyrolysis facility 20 may not pass through a cooler or condenser between the location from where it is withdrawn from the pyrolysis facility 20 (e.g., the pyrolysis separator 24 shown in FIG. 1) and where it is introduced into the cracker furnace 32.

In some embodiments, at least 50, at least 60, at least 70, at least 75, at least 80, at least 85, at least 90, at least 95, or at least 99 weight percent of the r-pyrolysis vapor 112 has not been condensed when it is introduced into the cracker furnace 32. The r-pyrolysis vapor 112 can have a vapor mass fraction that does not drop below 0.75, below 0.80, below 0.85, or 0.90 as it travels from the pyrolysis facility 20 to the cracker furnace 32. Less than 50, less than 40, less than 30, less than 25, less than 15, less than 10, less than 5, less than 2, less than 1, or less than 0.5 weight percent of the r-pyrolysis vapor 112 is condensed as it travels from the pyrolysis facility 20 and the cracker furnace 32.

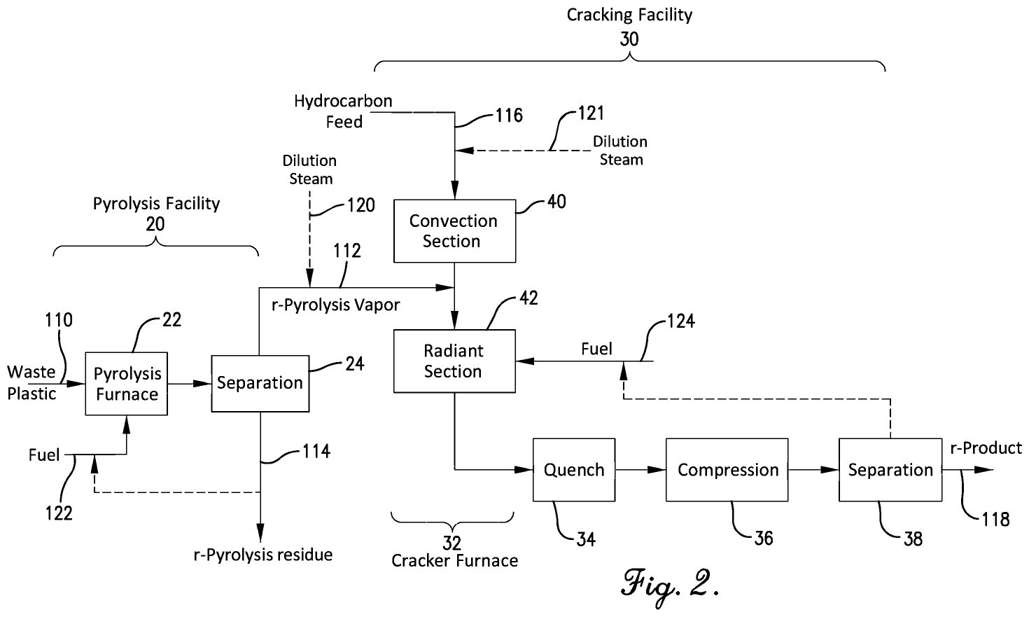

Turning now to FIG. 2, a block flow diagram of the process/facility shown in FIG. 1 is provided, particularly highlighting a specific location for introducing the r-pyrolysis vapor into the cracker furnace 32. As shown in FIG. 2, the cracker furnace 32 includes a convection section 40 followed by a radiant section 42. A hydrocarbon feed 116 introduced into the convection section 40 is optionally combined with dilution steam 121 before being introduced into the radiant section 42, wherein the hydrocarbon components are thermally cracked to form lower molecular weight components such as ethane, ethylene, propane, propylene, and others.

In some embodiments, the hydrocarbon feed 116 introduced into the cracker furnace 32 can comprise predominantly C2 to C5 hydrocarbon components, predominantly C2 to C4 hydrocarbon components, predominantly C2 hydrocarbon components, or predominantly C3 hydrocarbon components. As used herein, the term “predominantly” means at least 50 weight percent. In such cases, the hydrocarbon feed 116 may be in the gas phase and the cracker furnace 32 may be considered a gas cracker furnace.

In other embodiments, the hydrocarbon feed 116 may comprise predominantly C5 to C22 hydrocarbon components, or predominantly C5 to C20 components, or predominantly C5 to C18 components. In such cases, the hydrocarbon feed may be in the liquid phase and the cracker furnace 32 may be considered a liquid cracker furnace. Alternatively, at least a portion of the furnace coils in the cracker furnace 32 may be configured to receive and process a gas phase hydrocarbon feed and at least a portion of the furnace coils in the cracker furnace 32 may be configured to process a liquid hydrocarbon feed so that the cracker furnace 32 may be considered a split furnace.

In some embodiments, the hydrocarbon feed 116 introduced into the cracker furnace 32 can comprise a recycled content hydrocarbon feed (r-HC feed). The r-HC feed can directly or indirectly include recycled content from waste plastic. In some embodiments, the hydrocarbon feed 116 may comprise non-recycled content hydrocarbon, or it may not include any recycled content hydrocarbon.

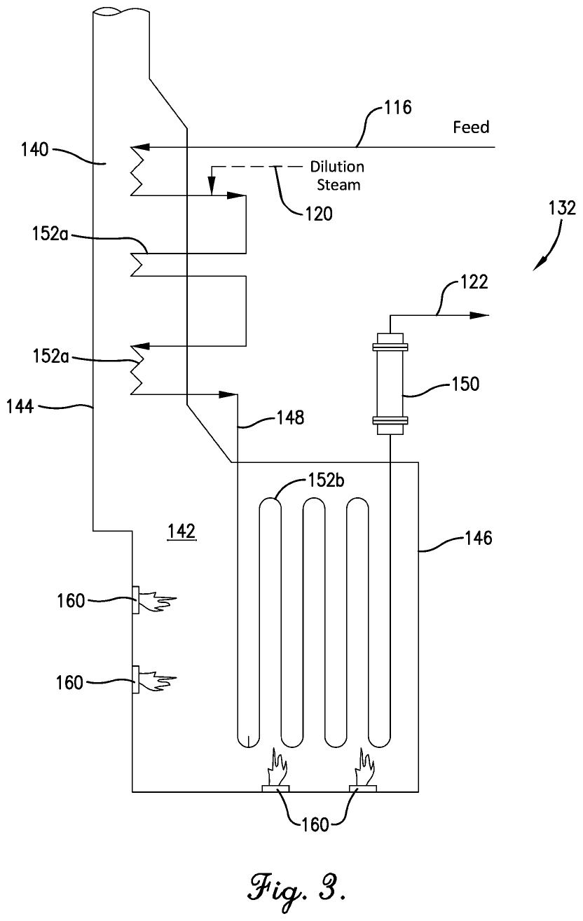

Referring now to FIG. 3, a schematic diagram of a cracker furnace 132 suitable for use in the cracking facility 30 shown in FIGS. 1 and 2 is provided. As shown in FIG. 3, the cracker furnace 132 includes a convection section 140, a radiant section 142, and at least one cross-over pipe 148 disposed between and connecting the convection section 140 with the radiant section 142. In operation, the cracker feed stream 116 introduced into the furnace 132 passes through a bank of tubes or coils 152a in the convection section 140 and is heated by hot flue gases ascending upwardly past the tubes 152a.

The cracker stream then passes through the cross-over pipe 148, which can be disposed within or external to the furnace, and into the inlet of the radiant section. The radiant section includes a plurality of burners 160 for providing high-temperature combustion gases to the furnace, and heat is transferred to the cracker stream as it passes through the tubes or coils 152b in firebox 146. As the cracker stream passe through the coils 152b in the radiant section, higher molecular weight hydrocarbons are cracked to lower molecular weight hydrocarbons, and the cracked effluent 122 is cooled after being removed from the furnace 132. Other configurations of a cracker furnace 132 may also be used including, for example, different shapes or configurations of tubes 152a and 152, as well as multiple convection boxes 144 and/or fire boxes 146.

Referring back to FIG. 2, at least a portion of the r-pyrolysis vapor 112 withdrawn from the pyrolysis facility 20 can be introduced into the transition section of the cracker furnace 32 between the convection section 40 and the radiant section 42. In some embodiments, the only location where r-pyrolysis vapor 112 is added is in the transition section of the furnace 32 so that the feed to the furnace 116 and the cracker stream passing through the convection section 40 include substantially no r-pyrolysis vapor 112. In such cases, the feed to the cracker furnace 116 and the cracker stream passing through the convection section 40 each comprise less than 5, less than 2, less than 1, less than 0.5, or less than 0.1 weight percent of r-pyrolysis vapor 112.

In order to ensure no liquids are added to the radiant section 42, the pyrolysis vapor 112 must be maintained at a temperature similar to (e.g., greater than or equal to) the temperature of the cracker stream at the location in the furnace to which the r-pyrolysis vapor 112 is introduced. To facilitate this, the pyrolysis facility and the cracker facility may be co-located such that the facilities are within 2, within 1, within 0.5, or within 0.1 mile of one another. Additionally, the travel path of the r-pyrolysis vapor (e.g., through pipes, valves, etc.) between the point of its withdrawal from the pyrolysis facility and its point of introduction into the cracking facility should be less than 10, less than 5, less than 3, less than 1, less than 0.5, less than 0.25, or less than 0.1 miles. In some cases, the pyrolysis and cracking facilities can be operated by the same commercial entity, while in other embodiments, two or more commercial entities may be operating the facilities such as, under a joint venture or other commercial agreement.

In some embodiments, the r-pyrolysis vapor 112 can be maintained at a temperature above 375, above 400, above 450, above 500, above 550, above 600° C. and/or less than 850, less than 800, less than 750, less than 700, less than 650, less than 600, less than 550° C. during the travel from the location from which it is withdrawn in the pyrolysis facility 20 to the location into which it is introduced in the cracking facility 30. Optionally, additional dilution steam 120 may be added to the r-pyrolysis vapor 112 prior to or at its introduction into the cracker furnace 32, as shown in FIG. 2.

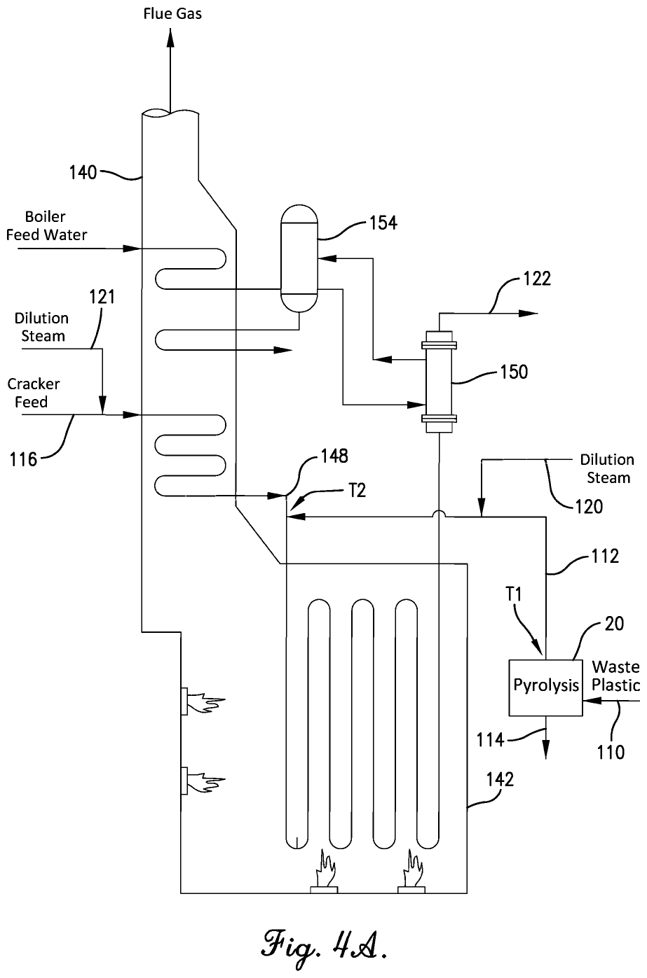

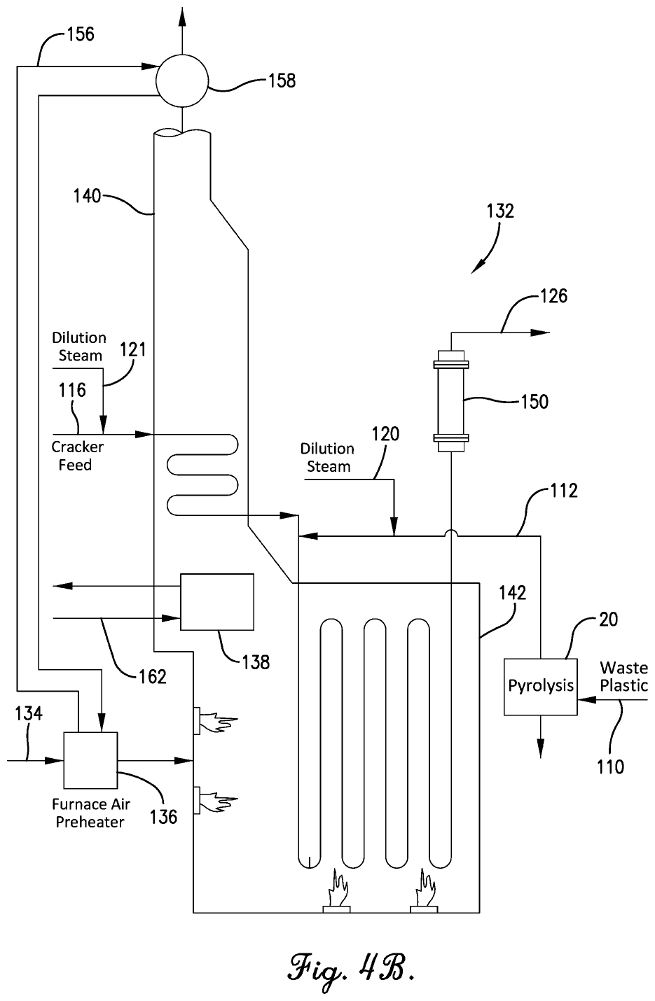

Turning now to FIG. 4a, a schematic diagram of a pyrolysis facility 20 and cracker furnace 132 is shown, particularly illustrating an embodiment wherein the r-pyrolysis vapor 112 can be introduced into cross-over pipe 148 of the cracker furnace 132. In particular, as shown in FIG. 4a, the r-pyrolysis vapor 112 can be combined with a hydrocarbon-containing cracker stream exiting the convection section 140 of the furnace 132 in the cross-over pipe 148. The hydrocarbon cracker stream exiting the convection section 140 includes at least a portion of the hydrocarbon cracker feed 116 introduced into the cracker furnace 132 as well as any dilution steam 121 added prior to the outlet of the convection section 140. In some cases, the steam-to-hydrocarbon ratio of the cracker stream entering the cross-over pipe 148 can be at least 0.45:1, at least 0.50:1, at least 0.55:1, or at least 0.60:1.

When introduced into the cross-over pipe 148 as shown in FIG. 4a, the pyrolysis vapor 112 can have nearly the same temperature it had when withdrawn from the pyrolysis facility 20. For example, when withdrawn from a first location within the pyrolysis facility 20 (e.g., the outlet of the separator 24 as shown in FIG. 1), the r-pyrolysis vapor 112 can have a first temperature, T1, and it can have a second temperature, T2, when introduced into a second location within the cracker furnace 132 (e.g., the cross-over pipe 148). In some cases, the absolute value of the difference between T2 and T1 can be not more than 250° C., not more than 200° C., not more than 175° C., not more than 150° C., or not more than 125° C.

T1 can be at least 350° C., at least 375° C., at least 400° C., at least 425° C., or at least 450° C. and/or it can be not more than 675° C., not more than 650° C., not more than 625° C., not more than 600° C., not more than 575° C., not more than 550° C., not more than 525° C., or not more than 500° C., measured at the location from which the r-pyrolysis vapor 112 is withdrawn from the pyrolysis facility 20. For example, T1 can be measured at the outlet of the separator 24 shown in FIG. 1 for removing r-pyrolysis residue from the r-pyrolysis reactor effluent. In some embodiments, T1 is within 250° C., within 200° C., within 150° C., within 100° C., or within 75° C. of the average temperature at which the pyrolysis reaction was carried out in the pyrolysis furnace shown in FIG. 1.

T2 can be at least 450° C., at least 475° C., at least 500° C., at least 525° C., at least 550° C., at least 575° C., at least 600° C., at least 625° C. and/or it can be not more than 800° C., not more than 775° C., not more than 750° C., not more than 725° C., not more than 700° C., or not more than 675° C., measured at the location into which the r-pyrolysis vapor 112 is introduced into the cracker furnace 132. For example, T2 can be measured at the location the r-pyrolysis vapor 112 enters the cross-over pipe 148 between the convection 140 and radiant 142 sections of the furnace 132, as shown in FIG. 4a.

As shown in FIG. 4a, dilution steam 120 may be added to the r-pyrolysis vapor 112 prior to its introduction into the cracker furnace 132. In addition to controlling the steam-to-hydrocarbon ratio in the radiant section 142 of the furnace 132, adding dilution steam 120 to the r-pyrolysis vapor 112 helps ensure that no liquid enters the radiant section 142. Although very little, if any, of the r-pyrolysis vapor 112 condenses before it is introduced into the cracker furnace 132, the addition of dilution steam 120 can provide additional energy to vaporize any minor amount of condensation. As a result, the vapor mass fraction of the r-pyrolysis vapor 112 introduced into the cracker furnace 132 (or cross-over pipe 148) can be at least 0.97, at least 0.98, at least 0.99, or 1.0.

Additionally, or alternatively, dilution steam 121 may be added to the hydrocarbon, or cracker, feed 116 introduced into the inlet of the convection section 140 of the cracker furnace 132. In some cases, dilution steam 121 can be added to the hydrocarbon feed 116 or dilution steam 120 may be added to the r-pyrolysis vapor 112 and not the other, while in other cases, it may be added to both. In some cases, the dilution steam 121 added to the hydrocarbon feed 116 can be saturated or superheated steam, while the dilution steam 120 added to the r-pyrolysis vapor 112 can be superheated.

In some embodiments, at least a portion of the dilution steam 120 or 121 can be formed by passing boiler feed water through tubes or coils in the convection section 140 of the cracker furnace, as generally shown in FIG. 4a. As also shown in FIG. 4a, the resulting steam can be passed through a steam drum 154 and any condensate separated and reheated to produce additional steam in the convection section 140 of the furnace 132 and/or in the exchanger 150 for cooling the cracked olefin effluent 122 from the radiant section 142. When the dilution steam 120 or 121 is superheated, the steam may be passed through one or more coils in the convection section 140 of the cracker furnace 132 and/or through an external heat exchanger (not shown).

When added to the r-pyrolysis vapor 112 as shown in FIG. 4a, the dilution steam 120 has a temperature that is the same as or higher than the temperature of the r-pyrolysis vapor 112. For example, the temperature of the dilution steam 120 can be not more than 5° C., 2° C., or 1° C. lower than the temperature of the r-pyrolysis vapor 112 at the point of combination and/or it can be at least 5° C., at least 10° C., at least 15° C., at least 20° C., at least 25° C., at least 50° C., at least 75° C., at least 100° C., at least 125° C., at least 150° C., at least 175° C., or at least 200° C. higher than the temperature of the r-pyrolysis vapor 112 at the combination point. In some cases, the dilution steam 120 may itself be preheated before being combined with the r-pyrolysis vapor 112. Such a pre-heating step can be carried out in any suitable heat exchanger, including in the convection section 140 of the cracker furnace 132 or one or more external exchangers (not shown).

Additionally, the dilution steam 120 added to the r-pyrolysis vapor is superheated steam (not saturated steam), so that no condensation of the steam occurs upon contact with the cooler r-pyrolysis vapor 112. In some cases, the additional heat available from the superheated dilution steam 112 can help re-vaporize any portion of the r-pyrolysis vapor 112 that may have condensed, so that the stream of r-pyrolysis vapor 112 introduced into the furnace 132 (or cross-over pipe 148) can be a vapor-phase stream.

As shown in FIG. 4a, the stream of r-pyrolysis vapor 112 (and optional dilution steam 120) can be combined with a hydrocarbon, or cracker, feed stream 116 introduced into and passed through the convection section 140 of the furnace 132. The amount of r-pyrolysis vapor 112 in the combined cracker stream (e.g., the hydrocarbon stream from the convection section 140, the r-pyrolysis vapor 112, and dilution steam 120) can be less than 50, less than 45, less than 40, less than 35, less than 30, less than 25, less than 20, less than 15, less than 10, less than 5, or less than 2 weight percent, based on the total weight of the stream. Additionally, or alternatively, the r-pyrolysis vapor 112 can be present in the combined stream entering the radiant section 142 in an amount of at least 1, at least 5, at least 10, at least 15, or at least 20 weight percent, based on the total weight of the stream.

The combined cracker stream can then pass through the coils in the radiant section 142 of the furnace 132, wherein the hydrocarbon components can be cracked to form lighter hydrocarbon components, including olefins. The cracked olefin effluent 122 withdrawn from the furnace 132 can be cooled in an exchanger 150, as shown in FIG. 4a.

Referring again to FIGS. 1 and 2, the cracked effluent from the radiant section 42 of the cracker furnace 32 can be passed to a quench zone 34, wherein the stream is further cooled by direct or indirect heat exchange. The resulting cooled stream is then compressed in a compression zone 34 before being separated to form one or more recycled content product (r-product) steams 118. Examples of r-product streams can include, but are not limited to, recycled content ethylene (r-ethylene), recycled content ethane (r-ethane), recycled content propylene (r-propylene), recycled content propane (r-propane), recycled content butylene (r-butylene), recycled content butane (r-butane), and recycled content C5 and heavier (r-C5+).

Turning back to FIG. 1, in some embodiments, at least a portion of the r-pyrolysis residue and/or at least one recycled content hydrocarbon stream (r-hydrocarbon stream) from the separation zone of the cracker facility may be used as fuel for the pyrolysis furnace 22 and/or cracker furnace 32. Such utilization may reduce the amount of conventional fuels required and/or may result in less generation of carbon dioxide in the flue gases of the pyrolysis furnace 22 and/or cracker furnace 32, depending on the composition and amount of these streams used as fuel.

In some cases, an existing cracker furnace can be retrofitted to begin accepting r-pyrolysis vapor from a nearby (e.g., co-located) pyrolysis facility. Such a retrofit includes modifications to the cracker furnace itself in order to maintain the heat balance of the furnace. Examples of specific modifications are shown in FIG. 4b and discussed in further detail below.

Turning now to FIG. 4b, in some cases, the flow rate of hydrocarbon, or cracker, feed 116 introduced into the convection section 140 of the furnace 132 may be reduced in order to accommodate the flow rate of r-pyrolysis vapor 112 added at the cross-over pipe 148. As a result, the flow rate of the total stream added to the radiant section 142 (e.g., hydrocarbon feed 116, r-pyrolysis vapor 112, and dilution steam 120) remains the same as previously, when no r-pyrolysis vapor 112 was added to the furnace 132. In some embodiments, the mass (or volumetric) flow rate of the hydrocarbon feed 116 to the convection section of the cracker furnace can be reduced by at least 5, at least 10, at least 15, at least 20, at least 25, or at least 30 percent when the r-pyrolysis vapor 112 is introduced into the cross-over pipe 148, as compared to similar conditions with no r-pyrolysis vapor is 112 added.

In order to maintain the heat balance and temperature profile of the furnace 132, one or more modifications can be made to utilize the additional heat recoverable from the convection section 140 of the furnace 132. For example, as shown in FIG. 4b, one or more heat recovery systems can be added to the furnace 132. One example of a heat recovery system shown in FIG. 4b is a furnace air preheater 136. Furnace combustion air 134 can be heated in the preheater 136 via heat exchange with a warmed heat transfer medium 156. Examples of suitable heat transfer media include, but are not limited to, boiler feed water, condensate, steam, mineral oil, and synthetic heat transfer media such as THERMINOL®.

As shown in FIG. 4b, the heat transfer medium 156 may be warmed in an exchanger 158 via indirect heat exchange with the flue gas exiting the furnace 132. Additional heat available in the flue gas due to reduced flow of cracker feed within the convection section 140 can be recovered by the heat transfer medium 156 and used to pre-heat the furnace combustion air 134. The resulting cooled heat transfer medium 156 can be returned to the exchanger 158, wherein it can be reheated and again returned to the air preheater 136.

Another type of heat recovery system shown in FIG. 4b is a steam generator 138, which can be disposed within the shell of the cracker furnace 132. Steam generator 138 can receive and heat an inlet stream 162 to form an outlet stream of steam. In some cases, the inlet stream 162 can be boiler feed water or condensate heated to form saturated or superheated steam, while, in other cases, the inlet stream 162 can be saturated steam heated to form superheated steam. In some cases, at least a portion of the dilution steam 121 added to the cracker feed 116 and/or the dilution steam 120 added to the r-pyrolysis vapor 112 may comprise steam formed or heated in the steam generator 138.

In some embodiments, the modification to the cracker furnace 132 can include modifying how the dilution steam 120 is added to the convection section 140 of cracker furnace 132. For example, this may include adding more dilution steam 120 into the convection section 140 of the furnace 132. Not only will this provide the usual function of temperature and cracking control in the convection section, it will also help ensure a desirable steam-to-hydrocarbon ratio in the radiant section 142 of the furnace 132. For example, the addition of more dilution steam 120 to the hydrocarbon feed 116 in the convection section 140 may result in a higher-than-usual steam-to-hydrocarbon ratio such as at least 0.20:1, at least 0.25:1, at least 0.30:1, at least 0.45:1, at least 0.50:1, at least 0.55:1, or at least 0.60:1. When the hydrocarbon-containing r-pyrolysis vapor 112 is added at the cross-over pipe 148, then the steam-to-hydrocarbon ratio in the resulting combined stream (e.g., hydrocarbon stream 116, r-pyrolysis vapor 112, and dilution steam 120) can be in the range of from 0.10:1 to 0.40:1, 0.15:1 to 0.35:1, or 0.20:1 to 0.30:1.

In such cases, little or no dilution steam may be added to the r-pyrolysis vapor 112 prior to entering the furnace 132 (or cross-over pipe 148). The increased rate of dilution steam 120 addition can be carried out by adding more steam to the hydrocarbon feed 116 fed to the convection section 140 and/or by adding more steam to one or more coils in the convection section 140 (not shown).

In some embodiments, the modification to the addition of the dilution steam 120 may include combining the cracker or hydrocarbon feed 116 with boiler feed water (not shown) and passing the combined stream through the convection section 140. As the stream is heated in the convection section 140, dilution steam can be generated in situ, which also utilizes some of the additional heat present in the convection section due to the reduction in hydrocarbon feed 116. While described with respect to boiler feed water, any other suitable source of water for steam generation can be used, such as, for example, stripped water from the plant water stripper, condensate, and/or water typically fed to the dilution steam generator (not shown). Combinations of water from one or more of these sources can also be utilized.

In one embodiment or in combination with one or more embodiments disclosed herein, the pyrolysis reaction performed in the pyrolysis reactor can be carried out at a temperature of less than 700, less than 650, or less than 600° C. and at least 300, at least 350, or at least 400° C. The feed to the pyrolysis reactor can comprise, consists essentially of, or consists of waste plastic. The feed stream, and/or the waste plastic component of the feed stream, can have a number average molecular weight (Mn) of at least 3000, at least 4000, at least 5000, or at least 6000 g/mole. If the feed to the pyrolysis reactor contains a mixture of components, the Mn of the pyrolysis feed is the weighted average Mn of all feed components, based on the mass of the individual feed components. The waste plastic in the feed to the pyrolysis reactor can include post-consumer waste plastic, post-industrial waste plastic, or combinations thereof. In certain embodiments, the feed to the pyrolysis reactor comprises less than 5, less than 2, less than 1, less than 0.5, or about 0.0 weight percent coal and/or biomass (e.g., lignocellulosic waste, switchgrass, fats and oils derived from animals, fats and oils derived from plants, etc.), based on the weight of solids in pyrolysis feed or based on the weight of the entire pyrolysis feed. The feed to the pyrolysis reaction can also comprise less than 5, less than 2, less than 1, or less than 0.5, or about 0.0 weight percent of a co-feed stream, including steam, sulfur-containing co-feed streams, and/or non-plastic hydrocarbons (e.g., non-plastic hydrocarbons having less than 50, less than 30, or less than 20 carbon atoms), based on the weight of the entire pyrolysis feed other than water or based on the weight of the entire pyrolysis feed.

Additionally, or alternatively, the pyrolysis reactor may comprise a film reactor, a screw extruder, a tubular reactor, a stirred tank reactor, a riser reactor, a fixed bed reactor, a fluidized bed reactor, a rotary kiln, a vacuum reactor, a microwave reactor, or an autoclave. The reactor may also utilize a feed gas and/or lift gas for facilitating the introduction of the feed into the pyrolysis reactor. The feed gas and/or lift gas can comprise nitrogen and can comprise less than 5, less than 2, less than 1, or less than 0.5, or about 0.0 weight percent of steam and/or sulfur-containing compounds.

In one embodiment or in combination with one or more embodiments disclosed herein, the cracker furnace can be operated at a product outlet temperature (e.g., coil outlet temperature) of at least 700, at least 750, at least 800, or at least 850° C. The feed to the cracker furnace can have a number average molecular weight (Mn) of less than 3000, less than 2000, less than 1000, or less than 500 g/mole. If the feed to the cracker furnace contains a mixture of components, the Mn of the cracker feed is the weighted average Mn of all feed components, based on the mass of the individual feed components. The feed to the cracker furnace can comprise less than 5, less than 2, less than 1, less than 0.5, or 0.0 weight percent of coal, biomass, and/or solids. In certain embodiments, a co-feed stream, such as steam or a sulfur-containing stream (for metal passivation) can be introduced into the cracker furnace. The cracker furnace can include both convection and radiant sections and can have a tubular reaction zone (e.g., coils in one or both of the convection and radiant sections). Typically, the residence time of the streams passing through the reaction zone (from the convection section inlet to the radiant section outlet) can be less than 20 seconds, less than 10 seconds, less than 5 seconds, or less than 2 seconds.

When a numerical sequence is indicated, it is to be understood that each number is modified the same as the first number or last number in the numerical sequence or in the sentence, e.g., each number is “at least,” or “up to” or “not more than” as the case may be; and each number is in an “or” relationship. For example, “at least 10, 20, 30, 40, 50, 75 wt. % . . . ” means the same as “at least 10 wt. %, or at least 20 wt. %, or at least 30 wt. %, or at least 40 wt. %, or at least 50 wt. %, or at least 75 wt. %,” etc.; and “not more than 90 wt. %, 85, 70, 60 . . . ” means the same as “not more than 90 wt. %, or not more than 85 wt. %, or not more than 70 wt. % . . . ” etc.; and “at least 1%, 2%, 3%, 4%, 5%, 6%, 7%, 8%, 9% or 10% by weight . . . ” means the same as “at least 1 wt. %, or at least 2 wt. %, or at least 3 wt. % . . . ” etc.; and “at least 5, 10, 15, 20 and/or not more than 99, 95, 90 weight percent” means the same as “at least 5 wt. %, or at least 10 wt. %, or at least 15 wt. % or at least 20 wt. % and/or not more than 99 wt. %, or not more than 95 wt. %, or not more than 90 weight percent . . . ” etc.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and propylene) that are useful by themselves and/or are useful as feedstocks to another chemical production process(es).

As used herein, the term “co-located” refers to the characteristic of at least two objects being situated on a common physical site, and/or within one mile of each other.

As used herein, the term “commercial scale facility” refers to a facility having an average annual feed rate of at least 500 pounds per hour, averaged over one year.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the term “cracking” refers to breaking down complex organic molecules into simpler molecules by the breaking of carbon-carbon bonds.

As used herein, the terms “including,” “include,” and “included” have the same open-ended meaning as “comprising,” “comprises,” and “comprise” provided above.

As used herein, the term “predominantly” means more than 50 percent by weight. For example, a predominantly propane stream, composition, feedstock, or product is a stream, composition, feedstock, or product that contains more than 50 weight percent propane.

As used herein, the term “pyrolysis” refers to thermal decomposition of one or more organic materials at elevated temperatures in an inert (i.e., substantially oxygen free) atmosphere.

As used herein, the term “pyrolysis effluent” refers to the outlet stream withdrawn from the pyrolysis reactor in a pyrolysis facility.

As used herein, the terms “pyrolysis gas” and “pygas” refer to a composition obtained from pyrolysis that is gaseous at 25° C.

As used herein, the terms “pyrolysis oil” or “pyoil” refers to a composition obtained from pyrolysis that is liquid at 25° C. and 1 atm.

As used herein, the term “pyrolysis residue” refers to a composition obtained from pyrolysis that is not pyrolysis gas or pyrolysis oil and that comprises predominantly pyrolysis char and pyrolysis heavy waxes.

As used herein, the term “pyrolysis vapor” refers to the overhead or vapor-phase stream withdrawn from the separator in a pyrolysis facility used to remove r-pyrolysis residue from the r-pyrolysis effluent.

As used herein, the term “recycled content” refers to being or comprising a composition that is directly and/or indirectly derived from recycled material.

As used herein, the term “waste material” refers to used, scrap, and/or discarded material.

As used herein, the terms “waste plastic” and “plastic waste” refer to used, scrap, and/or discarded plastic materials.

### Additional Claim Supporting Description—First Embodiment

In a first embodiment of the present technology there is provided a recycled content hydrocarbon product (r-product), the process comprising: (a) pyrolyzing waste plastic in a pyrolysis facility to thereby produce a recycled content pyrolysis vapor (r-pyrolysis vapor); (b) withdrawing at least a portion of the r-pyrolysis vapor from a first location within the pyrolysis facility, wherein the r-pyrolysis vapor has a temperature at the first location, T1; (c) combining the r-pyrolysis vapor with a cracker stream to form a combined cracker stream a second location within a cracker furnace of a co-located cracking facility, wherein the r-pyrolysis vapor has a temperature at the second location, T2; and (d) cracking the combined cracker stream in the cracker furnace to form a recycled content olefin-containing effluent (r-olefin effluent), wherein the absolute value of the difference between T2 and T1 is not more than 250° C.

The first embodiment described in the preceding paragraph can also include one or more of the additional aspects/features listed in the following bullet pointed paragraphs. Each of the below additional features of the first embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
wherein T2 is not more than 800 (775, 750, 725, 700, or 675° C.)
wherein T1 is higher than T2.
wherein the absolute value of the difference between T2 and T1 is not more than 225 (200, 175, or 150° C.)
wherein T1 is at least 350 (375, 400, 425, or 450°) C and/or not more than 675 (650, 625, 600, 575, 550, 525, or 500° C.)
wherein T2 is at least 500 (525, 550, 575, 600, 625°) C and/or not more than 850 (825, 800, 775, 750, 725, 700° C.)
wherein less than 50 (40, 30, 25, 20, 15, 10, 5, 2, 1, 0.5) percent of the r-pyrolysis vapor is condensed as it travels between the first location within the pyrolysis facility and the second location within the cracker facility.
wherein the vapor mass fraction of the r-pyrolysis vapor does not drop below 0.75 (0.85, 0.90) between the first and second locations.
wherein the r-pyrolysis vapor does not pass through a heat exchanger, cooler, or condenser between the withdrawing of step (b) and the combining of step (c).
wherein the r-pyrolysis vapor does not pass through a cooler or condenser between the withdrawing of step (b) and the combining of step (c).
further comprising separating out at least a portion of the recycled content wax (r-wax) from the r-pyrolysis vapor before introducing it into the cross-over pipe.
wherein the r-pyrolysis vapor is not separated between the withdrawing of step (b) and the combining of step (c).
wherein T1 is within 250 (200, 150, 100, 75° C.) of the average temperature at which the pyrolyzing of step (a) is conducted.
wherein the travel path of the r-pyrolysis vapor between the first and second location is less than 10 (5, 2, 1, 0.5, 0.25, or 0.1) miles.
wherein the r-pyrolysis vapor is present in the combined stream in an amount that is less than 35 (30, 25, 20, 15, 10, or 5) weight percent.
wherein the second location is at a cross-over pipe of the cracker furnace.
further comprising adding dilution steam to one or more locations within the pyrolysis furnace.
   wherein at least a portion of the dilution steam is added to the cracker feed prior to the combining of step (c).
   wherein at least a portion of the dilution steam is added to the r-pyrolysis vapor prior to the combining of step (c).
      wherein the temperature of the dilution steam is the same as or higher than the temperature of the r-pyrolysis vapor at the point of addition.
      wherein the temperature of the dilution steam is at least 5 (10, 15, 20, 25, 50, 75, 100, 125, 150, 175, or 200°) C higher than the temperature of the r-pyrolysis vapor at the point of addition.
      further comprising heating the steam and adding the heated steam to the r-pyrolysis vapor.
         wherein at least a portion of the steam is heated in a convection section of the cracker furnace to provide heated steam.
   wherein the dilution steam is superheated steam.
wherein the cracker feed to a convection section of the furnace comprises predominantly C5 to C22 hydrocarbons.
wherein the cracker feed to a convection section of the furnace comprises predominantly C2 to C5 hydrocarbons.
wherein the cracker feed comprises recycled content derived from waste plastic.
wherein the cracker feed comprises non-recycled content.
wherein the r-pyrolysis vapor is at a minimum temperature of 350° C. (400, 450, 500, 550, 600° C.) as it is passed from the first location in the pyrolysis facility to the second location in the cracker facility.
wherein the r-pyrolysis vapor comprises greater than 30 (35, 40, 45, 50, 55, 60, 65, 70, 75, 80, or 85) weight percent of C5 (C6, C8, C10) and heavier components.
wherein at least 75 (90, 95, 99) weight percent of the r-pyrolysis vapor is C1 to C30 hydrocarbon components.
wherein the r-pyrolysis vapor stream has a vapor fraction of at least 0.97 (0.98, or 0.99) at the first location and a vapor fraction of at least 0.97 (0.98, or 0.99) at the second location.
further comprising, subsequent to the pyrolyzing and prior to the withdrawing, separating a pyrolysis reactor effluent stream to form the r-pyrolysis vapor and a recycled content pyrolysis residue (r-pyrolysis residue) stream in a separator.
   wherein the first location in the pyrolysis facility is an outlet of the separator.
   wherein the r-pyrolysis vapor comprises less than 10 (5, 2, 1, 0.5, 0.1) weight percent of the r-pyrolysis residue.
   wherein the r-pyrolysis vapor comprises at least 10 (25, 50, 75, or 90) weight percent of recycled content pyrolysis oil (r-pyoil).
   wherein the r-pyrolysis vapor comprises less than 75 (50, 25, or 10) weight percent of recycled content pyrolysis gas (r-pygas).
wherein the first location is the outlet of a separator in the pyrolysis facility for separating an effluent steam from a pyrolysis reactor into the r-pyrolysis vapor and a recycled content pyrolysis residue (r-pyrolysis residue).
wherein the second location is within the cracker furnace.
   wherein the cracker furnace has a convection section, a radiant section, and a cross-over pipe between the convention and radiant sections, wherein the second location is at the cross-over pipe.
further comprising separating at least a portion of the r-olefin effluent in a separation zone of the cracker facility to thereby produce at least one recycled content product (r-product).
wherein the r-product comprises at least one of recycled content ethane (r-ethane), recycled content ethylene (r-ethylene), recycled content propane (r-propane), recycled content propylene (r-propylene), recycled content butane (r-butane), recycled content butylene (r-butylene), and recycled content C5 and heavier (r-C5+).

### Additional Claim Supporting Description—Second Embodiment

In a second embodiment of the present technology there is provided a process for making a recycled content hydrocarbon product (r-product), the process comprising: (a) pyrolyzing waste plastic in a pyrolysis facility to thereby produce a recycled content pyrolysis vapor (r-pyrolysis vapor); and (b) introducing at least a portion of the r-pyrolysis vapor into a cross-over pipe of a cracker furnace in a cracking facility, wherein at least 50 weight percent of the r-pyrolysis vapor introduced into the cross-over pipe in step (b) has not been condensed.

The second embodiment described in the preceding paragraph can also include one or more of the additional aspects/features listed in the following bullet pointed paragraphs. Each of the below additional features of the second embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
further comprising introducing dilution steam into the cracker furnace.
   wherein the dilution steam is introduced in a location upstream of the cross-over pipe in a convection section.
   wherein the dilution steam is combined with the r-pyrolysis vapor prior to the introducing of step (b).
      further comprising heating the steam prior to combination with the r-pyrolysis vapor.
   wherein at least a portion of the dilution steam was generated within the cracker furnace.
wherein the pyrolyzing includes pyrolyzing waste plastic in a pyrolysis reactor to form a pyrolysis reactor effluent and separating the pyrolysis reactor effluent to form a recycled content pyrolysis residue (r-pyrolysis residue) and the (r-pyrolysis vapor).
   wherein the pyrolyzing is carried out at a temperature of 325 to 800° C. and a pressure of 0.1 to 60 barg.
   wherein the pyrolysis is thermal pyrolysis.
wherein the r-pyrolysis vapor comprises at least 5 (10, 15, 20, 25, 30, 35, or 40) and/or not more than 75 (70, 65, 60, 55, 50, or 40) weight percent of recycled content pyrolysis gas (r-pygas).
wherein the r-pyrolysis vapor comprises at least 5 (10, 15, 20, 25, 30, or 35) and/or not more than 65 (60, 55, 50, 45, or 40) weight percent of recycled content pyrolysis oil (r-pyoil).
wherein at least 50 (75, 90, 95) weight percent of the r-pyrolysis vapor withdrawn from the pyrolysis facility is introduced into the cracker furnace in step (b).
wherein the r-pyrolysis vapor comprises less than 15 (10, 5, 3, 2, 1, 0.5) weight percent of recycled content solids (r-solids).
   further comprising, separating out at least a portion of the r-solids prior to said combining of step (c).
wherein at least 60 (70, 75, 80, 85, 90, 95, or 99) weight percent of the r-pyrolysis vapor introduced into the cross-over pipe has not been condensed.
wherein the r-pyrolysis vapor comprises greater than 30 (35, 40, 45, 50, 55, 60, 65, 70, 75, 80, or 85) weight percent of C5 (C6, C8, C10) and heavier components.
wherein at least 75 (90, 95, 99) weight percent of the r-pyrolysis vapor is C1 to C30 hydrocarbon components.
wherein the r-pyrolysis vapor has an average temperature of at least 375 (400, 450, 500, 550, 600) and/or not more than 850 (800, 750, 700, 650, 600, 550° C.)
further comprising, introducing a hydrocarbon-containing feed stream into the inlet of the cracker furnace, and cracking the hydrocarbon-containing feed stream and the r-pyrolysis vapor.
   wherein the hydrocarbon-containing feed stream is a recycled content hydrocarbon-containing feed (r-HC feed).
   wherein the hydrocarbon-containing feed stream is a predominantly C2 to C4 hydrocarbon feed stream.
   wherein the hydrocarbon-containing feed stream is a predominantly C5 to C22 hydrocarbon feed stream.
further comprising cracking the r-pyrolysis vapor in a radiant section of the cracker furnace to form a recycled content furnace effluent (r-furnace effluent).
   further comprising separating at least a portion of the r-furnace effluent into one or more recycled content products (r-products) in the cracking facility.
      wherein the r-product comprises at least one of recycled content ethane (r-ethane), recycled content ethylene (r-ethylene), recycled content propane (r-propane), recycled content propylene (r-propylene), recycled content butane (r-butane), recycled content butylene (r-butylene), and recycled content C5 and heavier (r-C5+).
wherein the distance between the pyrolysis facility and the cracking facility is less than 2 (1, 0.75, 0.5, or 0.1) miles.
wherein the pyrolysis facility and the cracking facility are operated by directly or indirectly related commercial entities.

### Additional Claim Supporting Description—Third Embodiment

In a third embodiment of the present technology there is provided a process for making a recycled content hydrocarbon product (r-product), the process comprising: (a) pyrolyzing waste plastic in a pyrolysis facility to thereby produce a recycled content pyrolysis vapor (r-pyrolysis vapor); (b) cracking a hydrocarbon-containing cracker feed in a cracking furnace in a cracker facility to provide a cracked effluent, wherein the cracker furnace comprises a convection section, a radiant section, and a cross-over pipe therebetween, wherein none of the r-pyrolysis vapor is introduced into the cross-over pipe of the cracker furnace; (c) subsequent to step (b), reducing the flow rate of cracker feed to the convection section; (d) subsequent to step (c), initiating the introduction of at least a portion of the r-pyrolysis vapor into the cross-over pipe of the cracker furnace; and (e) modifying the convection section of the cracker furnace or its operation to maintain a furnace heat balance despite the reduction in cracker feed to the convection section.

The third embodiment described in the preceding paragraph can also include one or more of the additional aspects/features listed in the following bullet pointed paragraphs. Each of the below additional features of the third embodiment can be standalone features or can be combined with one or more of the other additional features to the extent consistent. Additionally, the following bullet pointed paragraphs can be viewed as dependent claim features having levels of dependency indicated by the degree of indention in the bulleted list (i.e., a feature indented further than the feature(s) listed above it is considered dependent on the feature(s) listed above it).
wherein the modifying includes adding water to the cracker feed to generate dilution steam in situ.
   wherein the water comprises boiler feed water, condensate, stripped water from a water stripper, water feed to the dilution steam generator, or combinations thereof.
wherein modifying includes adding a heat recovery system to the cracker furnace.
   wherein the heat recovery system recovers heat from a flue gas stream exiting the convection section of the cracker furnace.
      wherein the heat recovery system is used to preheat combustion air into one or more burners in the radiant section of the cracker furnace.
   wherein the heat recovery system includes at least one exchanger for generating steam.
   wherein the heat recovery system includes at least one exchanger for superheating steam.
      Multiple Dependent: wherein at least a portion of the steam generated in the exchanger is combined with the r-pyrolysis vapor prior to entering the radiant section of the cracker furnace.
wherein modifying includes increasing the rate of dilution steam fed to the convection section of the cracker furnace.
   wherein modifying includes increasing the rate of dilution steam combined with the cracker feed prior to the inlet of the cracker furnace.
   wherein the modifying includes increasing the rate of dilution steam combined with the cracker stream prior to the inlet of the radiant section and wherein no dilution steam is added to the r-pyrolysis vapor prior to the inlet of the radiant section, and wherein the steam-to-hydrocarbon ratio of the combined cracker stream in the radiant section is at least 0.20, 0.25, 0.30, 0.35 and/or not more than 0.55, 0.50, 0.45, or 0.40.
   wherein the modifying includes increasing the rate of dilution steam added to at least one furnace coil in the convection section of the furnace.
   wherein cracker stream in the convection section of the furnace comprises no r-pyrolysis vapor and has a steam-to-hydrocarbon ratio of at least 0.45, 0.50, 0.55, or 0.60 and wherein the cracker stream in the radiant section of the furnace comprises at least 1, 5, 10, 15 and/or not more than 50, 45, 40, 35 weight percent r-pyrolysis vapor and has a steam-to-hydrocarbon ratio of at least 0.15, 0.20, 0.25, or 0.30.

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A process for making a recycled content hydrocarbon product (r-product), the process comprising:
(a) pyrolyzing waste plastic in a pyrolysis facility to thereby produce a recycled content pyrolysis vapor (r-pyrolysis vapor);
(b) withdrawing at least a portion of the r-pyrolysis vapor from a first location within the pyrolysis facility, wherein the r-pyrolysis vapor has a temperature at the first location, T1;
(c) combining the r-pyrolysis vapor with a cracker stream to form a combined cracker stream a second location within a cracker furnace of a co-located cracking facility, wherein the r-pyrolysis vapor has a temperature at the second location, T2; and
(d) cracking the combined cracker stream in the cracker furnace to form a recycled content olefin-containing effluent (r-olefin effluent),
wherein the absolute value of the difference between T2 and T1 is not more than 250° C.

2. The process of claim 1, wherein the absolute value of the difference between T2 and T1 is not more than 225, wherein T1 is at least 350° C. and not more than 675° C., and wherein T2 is at least 500° C. and not more than 850° C.

3. The process of claim 1, wherein less than 50 percent of the r-pyrolysis vapor is condensed as it travels between the first location within the pyrolysis facility and the second location within the cracker facility and wherein the travel path of the r-pyrolysis vapor between the first and second location is less than 5 miles.

4. The process of claim 1, wherein the r-pyrolysis vapor withdrawn from the pyrolysis facility does not pass through a cooler or condenser between the withdrawing of step (b) and the combining of step (c).

5. The process of claim 1, wherein T1 is within 250° C. of the average temperature at which the pyrolyzing of step (a) is conducted.

6. The process of claim 1, wherein the r-pyrolysis vapor is present in the combined stream in an amount that is less than 35 weight percent.

7. The process of claim 1, further comprising adding dilution steam to one or more locations within the pyrolysis furnace, wherein at least a portion of the dilution steam is added to the r-pyrolysis vapor prior to the combining of step (c).

8. The process of claim 7, further comprising heating the steam and adding the heated steam to the r-pyrolysis vapor, wherein at least a portion of the steam is heated in a convection section of the cracker furnace to provide heated steam.

9. The process of claim 1, wherein the cracker feed comprises recycled content derived from waste plastic.

10. The process of claim 1, wherein the first location is the outlet of a separator in the pyrolysis facility that separates an effluent steam from a pyrolysis reactor into the r-pyrolysis vapor and a recycled content pyrolysis residue (r-pyrolysis residue) and wherein the second location is within the cracker furnace of the cracking facility, wherein the cracker furnace has a convection section, a radiant section, and a cross-over pipe between the convention and radiant sections, wherein the second location is at the cross-over pipe.

11. A process for making a recycled content hydrocarbon product (r-product), the process comprising:
(a) pyrolyzing waste plastic in a pyrolysis facility to thereby produce a recycled content pyrolysis vapor (r-pyrolysis vapor); and
(b) introducing at least a portion of the r-pyrolysis vapor into a cross-over pipe of a cracker furnace in a cracking facility,
wherein at least 50 weight percent of the r-pyrolysis vapor introduced into the cross-over pipe in step (b) has not been condensed.

12. The process of claim 11, wherein at least 85 weight percent of the r-pyrolysis vapor withdrawn from the pyrolysis facility is introduced into the cracker furnace in step (b).

13. The process of claim 11, further comprising combining dilution steam with the r-pyrolysis vapor prior to the introducing of step (b), further comprising heating the steam prior to combination with the r-pyrolysis vapor, wherein at least a portion of the dilution steam was generated within the cracker furnace.

14. The process of claim 11, wherein the pyrolyzing includes pyrolyzing waste plastic in a pyrolysis reactor to form a pyrolysis reactor effluent and separating the pyrolysis reactor effluent to form a recycled content pyrolysis residue (r-pyrolysis residue) and the (r-pyrolysis vapor) and wherein the r-pyrolysis vapor comprises at least 5 and not more than 75 weight percent of recycled content pyrolysis gas (r-pygas), wherein the r-pyrolysis vapor comprises at least 5 and not more than 65 weight percent of recycled content pyrolysis oil (r-pyoil), wherein the r-pyrolysis vapor comprises less than 15 weight percent of recycled content solids (r-solids).

15. A process for making a recycled content hydrocarbon product (r-product), the process comprising:
(a) pyrolyzing waste plastic in a pyrolysis facility to thereby produce a recycled content pyrolysis vapor (r-pyrolysis vapor);
(b) cracking a hydrocarbon-containing cracker feed in a cracking furnace in a cracker facility to provide a cracked effluent, wherein the cracker furnace comprises a convection section, a radiant section, and a cross-over pipe therebetween, wherein none of the r-pyrolysis vapor is introduced into the cross-over pipe of the cracker furnace;
(c) subsequent to step (b), reducing the flow rate of cracker feed to the convection section;
(d) subsequent to step (c), initiating the introduction of at least a portion of the r-pyrolysis vapor into the cross-over pipe of the cracker furnace; and
(e) modifying the convection section of the cracker furnace or its operation to maintain a furnace heat balance despite the reduction in cracker feed to the convection section.

16. The process of claim 15, wherein modifying includes adding a heat recovery system to the cracker furnace.

17. The process of claim 15, wherein the heat recovery system includes at least one exchanger for generating or superheating steam.

18. The process of claim 17, wherein at least a portion of the steam from the exchanger is combined with the r-pyrolysis vapor prior to entering the radiant section of the cracker furnace.

19. The process of claim 15, wherein modifying includes increasing the rate of dilution steam fed to the convection section of the cracker furnace.

20. The process of claim 19, wherein cracker stream in the convection section of the furnace comprises no r-pyrolysis vapor and has a steam-to-hydrocarbon ratio of 0.45 to 0.75 and wherein the cracker stream in the radiant section of the furnace comprises at least 1 and not more than 50 weight percent r-pyrolysis vapor and has a steam-to-hydrocarbon ratio of at least 0.15 to 0.40.
